(19) United States
(12) Patent Application Publication
(10) Pub. No.: US 2004/0106438 A1
(43) Pub. Date: Jun. 3, 2004

(54) MOBILE PHONE AND RELATED METHOD CAPABLE OF DISPLAYING CUSTOMIZED ANIMATION

(76) Inventor: Wen-Jiang Chen, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,719

(22) Filed: Aug. 13, 2003

(30) Foreign Application Priority Data
Aug. 16, 2002 (TW) 091118588

(51) Int. Cl. H04M 1/00; H04B 7/00

(52) U.S. Cl. 455/566; 455/514

(57) ABSTRACT

A mobile phone and related method capable of displaying customized animation. The mobile phone includes a display, a memory, and a controller for controlling operations of the mobile phone. The memory stores an original image data, the controller is capable of generating a plurality of image data from the original image data to form a varying picture, and displaying the varying picture on the display according to parameters and time intervals specified by users so as to present customized animation.

### BACKGROUND OF INVENTION

1. Field of the Invention

The present invention relates to a mobile phone and related method capable of displaying customized animation, and more particularly, to a mobile phone and related method capable of calculating a plurality of varying pictures from a single picture to organize customized animation according to user settings.

2. Description of the Prior Art

In the modern information society, wide area radio communication systems have become one of the most frequently used communication channels. Typical radio communication systems are accomplished via mobile phones. With the advancement of technology, modern display devices allow mobile phones, in addition to providing voice communications, to act as personalized information processors, which help users access personal information, such as lists of addresses, date/time, and schedules.

Please refer to FIGS.1A and 1B, which are respectively a perspective view and a functional block diagram of a conventional mobile phone 10. The mobile phone 10 comprises a microphone 12A for voice communication, a speaker 12B, a radio module 12C, a controller 14 for controlling operations of the mobile phone 10, a display 16 for displaying pictures, a memory 18 (such as a flash memory) for storing non-volatile data, a volatile memory 20 for supporting the controller 14, and a control panel 22 for receiving control demands. An input apparatus on the control panel 22, such as keypad 23 in FIG.1A, is able to input control demands into the controller 14 for further controlling operations of the mobile phone 10. Programs or important data that the controller 14 requires are stored in the non-volatile memory 18, while the volatile memory is needed for operations of the controller 14. When the mobile phone 10 is used for voice communication, the microphone 12A receives voice, transforms it into an electronic sound signal 24A, and sends it to the radio module 12C, which encodes and modulates the sound signal 24A, and transmits it via radio. On the other hand, the radio module 12C receives a signal via radio, decodes and demodulates it into a communication signal 24B, and sends it to the speaker 12B, which transforms the communication signal 24B into sound waves understandable by a user to realize two-way communications.

Mobile phones in modern society have gradually become personalized data processors providing users with all kinds of useful data, such as lists of addresses and schedules established by users. This data is visual and must be shown on suitable display devices, and so IT manufacturers strive to research and develop improved display functionality. To facilitate enjoyment in using mobile phones, some IT manufacturers design displays to exhibit animation providing a user-friendly graphical interface (e.g. a welcome animation when starting a mobile phone). In addition, displays of modern mobile phones are typically liquid crystal displays (LCDs), and animations can be used as screen savers for preventing displays from generating residual images because of exhibiting fixed pictures for a long time.

Please refer to FIG.2. FIG.2 is a schematic diagram of an animation exhibited on the mobile phone 10. Generally speaking, animation uses persistence of vision, sequentially and quickly showing a plurality of varying pictures to let users see smooth animation. As showed in FIG.2, the memory 18 stores a plurality of image data PD(1), PD(2) . . . PD(N-1), and PD(N), which respectively correspond to pictures PI(l), PI(2) to PI(N-1), PI(N). When animation is exhibited on the display 16, the controller 14 sequentially loads the image data in the memory 18 into the volatile memory 20, and then transmits the image data to the display 16, which exhibits the animation based on the corresponding pictures.

The disadvantages of animation exhibited by the prior art are described below. First of all, animation is organized by a large number of pictures that require much memory for storing corresponding image data. If image data is reduced, the corresponding pictures are fewer and cannot be organized into a vivid animation; otherwise, more pictures have to be stored requiring much additional memory. Secondly, users cannot change animations as they wish. The process of making animations organized from a plurality of varying pictures, including designing these varying pictures and storing corresponding image data in the memory 18, is too complicated to be performed by most users. As a result, IT manufacturers usually produce general animations for all users. This falls short of user expectations of customizable consumer electronic products.

### SUMMARY OF INVENTION

It is therefore a primary objective of the present invention to provide a mobile phone and related method capable of displaying customized animation to solve the problems of the prior art.

In the prior art, animation displayed on a mobile phone is organized as a plurality of varying pictures stored in a memory. Image data corresponding to these pictures requires much memory. It is difficult for users to make customized animations, with typical users only being capable of using animations produced by manufacturers.

On the other hand, a mobile phone of the claimed invention exhibits animation by sequentially calculating a series of varying pictures according to image data corresponding to an original picture and an animation calculation rule, and by organizing animation based on these calculated varying pictures. Therefore in the claimed invention, it is only necessary to store the original picture, which does not require a lot of memory. Users are able to choose their favorite pictures as original pictures and adopt different animation calculation rules to make a mobile phone exhibit customized animation.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1A is a perspective view of a conventional mobile phone.

FIG. 1B is a functional block diagram of the mobile phone in FIG. 1A.

FIG. 2 is a schematic diagram of animation providing structure of the mobile phone in FIG. 1A.

FIG. 3A is a perspective view of the present invention mobile phone.

FIG. 3B is a functional block diagram of the mobile phone in FIG. 3A.

FIG. 4 is a schematic diagram of animation providing structure of the mobile phone in FIG. 3A.

FIGS. 5A-5D are schematic diagrams of varying pictures in a first embodiment of animation according to the present invention.

FIGS. 6A-6D are schematic diagrams of varying pictures in a second embodiment of animation according to the present invention.

FIGS. 7A-7D are schematic diagrams of varying pictures in a third embodiment of animation according to the present invention.

FIGS. 8A-8D are schematic diagrams of varying pictures in a fourth embodiment of animation according to the present invention.

FIGS. 9A-9D are schematic diagrams of varying pictures in a fifth embodiment of animation according to the present invention.

FIG. 10 is a flow chart of setting animation according to the present invention.

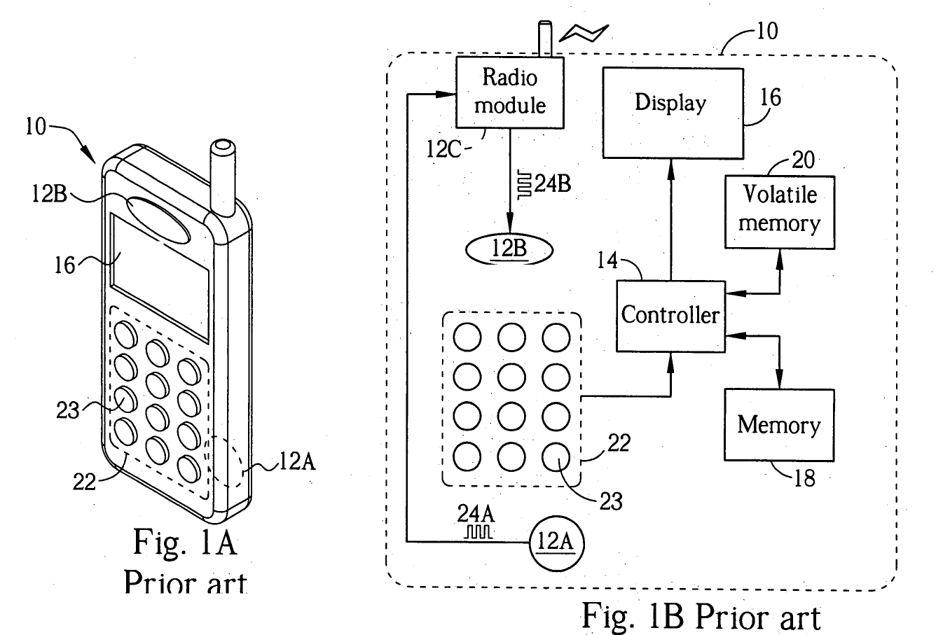

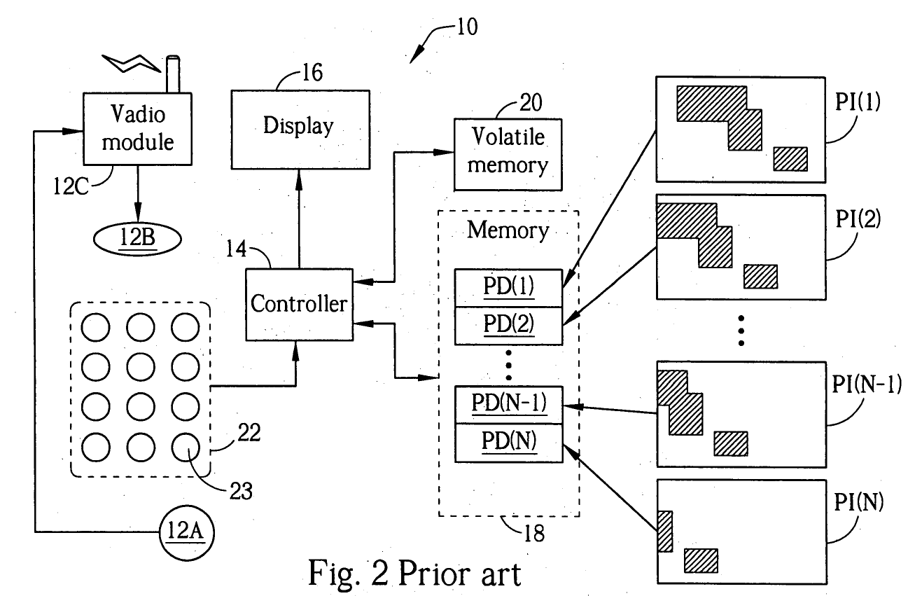

### DETAILED DESCRIPTION

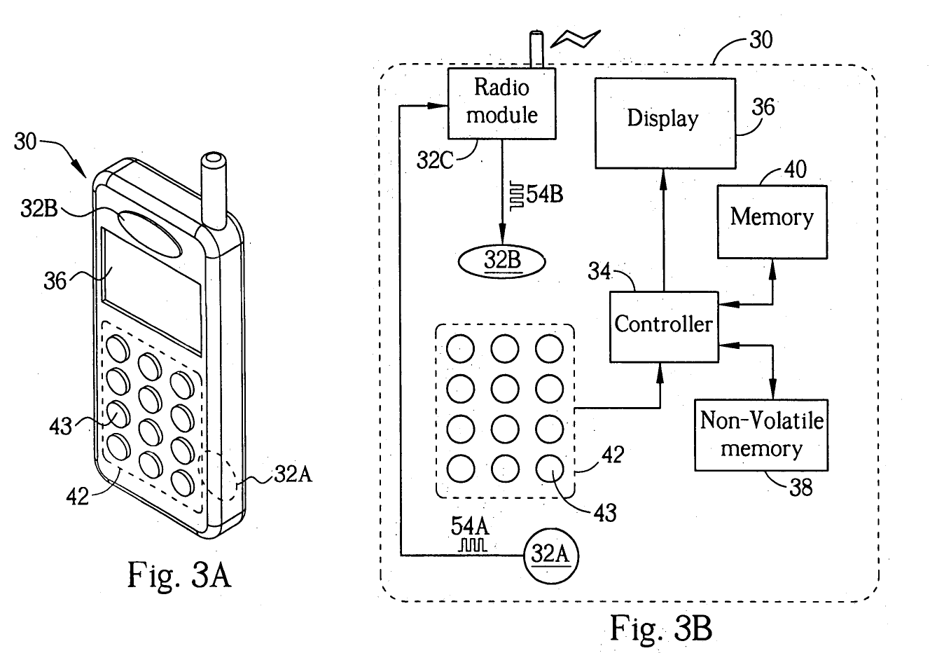

Please refer to FIGS. 3A and 3B, which are respectively a perspective view and a functional block diagram of a mobile phone 30 according to the present invention. The mobile phone 30 comprises a microphone 32A, speaker 32B, a radio module 32C, a controller 34, a display 36, a non-volatile memory 38, a memory 40, and a control panel 42. The controller 34 controls operations of the mobile phone 30. Users can input commands to the controller 34 through keypad 43 on the control panel 42. Another control apparatus can be used, for example, the control panel 42 can be touch panel combined with the display 36. The non-volatile memory 38 (e.g. flash memory) stores data for operations of the mobile phone 30, such as codes for controlling procedures of the controller 34 and user data, and the volatile memory 40 (e.g. DRAM) temporarily stores data for operation of the controller 34. The display 36 is electrically connected with the controller 34 to display pictures. When a user uses the mobile phone 30 for wireless communication, the user's voice is received by the microphone 32A and transformed into an electronic sound signal 54A, which is sent to the radio module 32C. The radio module 32C, modulating the sound signal 54A and transmitting it via radio, is also capable of receiving and demodulating a radio signal, and generating a communication signal 54B which is transformed into a sound wave by the speaker 32B for the user to hear. Through the aforementioned process, users are able to use the mobile phone 30 for two-ways communications.

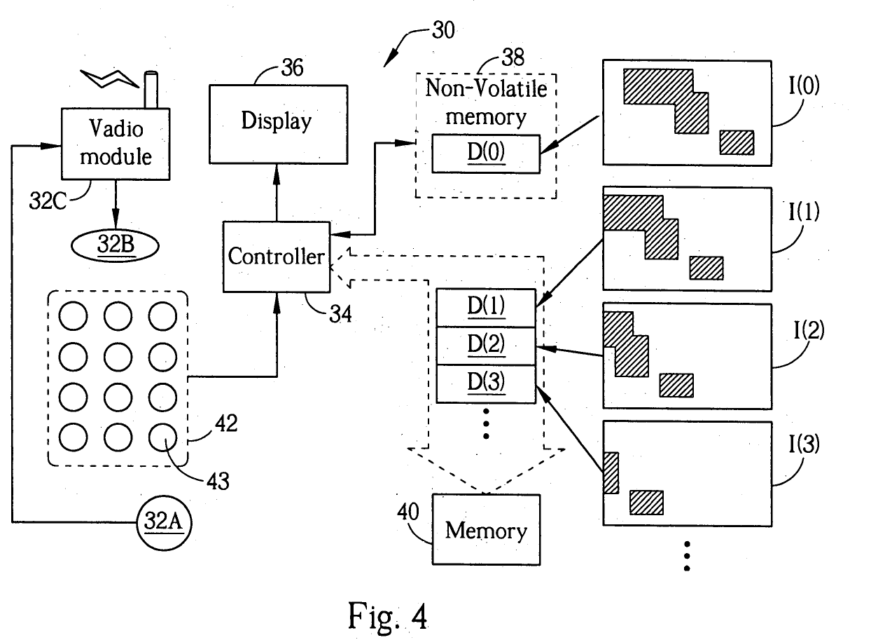

It is a feature of the present invention to calculate all of the varying pictures for animation from an original picture according to a predetermined animation calculation rule to display animation on the mobile phone 30. Please refer to FIG. 4, which is a schematic diagram of animation providing structure of the mobile phone 30. It is only necessary to store image data D(0) corresponding to an original picture I(0) in the memory 38. When the mobile phone 30 displays animation, the controller 34 calculates a plurality of image data D(1),D(2),D(3) . . . according to a predetermined animation calculation rule, and these image data respectively correspond to the varying pictures I(1),I(2),I(3) . . . The image data calculated by the controller 34 are temporarily stored in the memory 40, and then sent to the display 36 for displaying animation organized from the varying pictures. The controller 34 calculates all image data needed for animation at one time, or alternatively, generates only part of the image data. For example, if one animation needs sixteen varying pictures represented by sixteen pieces of corresponding image data, the controller 34 can first generate the first four pieces of image data, and then calculate the next four pieces of image data while the display 36 displays pictures corresponding to the first four pieces of image data. The controller 34 can also calculate the image data corresponding to one varying picture, and generate the image data corresponding to next varying picture while the previous varying picture is displayed in the display 36. The animation calculation rule can be recorded in the memory 38 as a program. When the controller 34 generates animation, the memory 38 reads the related program to calculate image data corresponding to all of the varying pictures. Optionally, the controller 34 could include a chip for exclusively calculating animation to accelerate the speed of calculation.

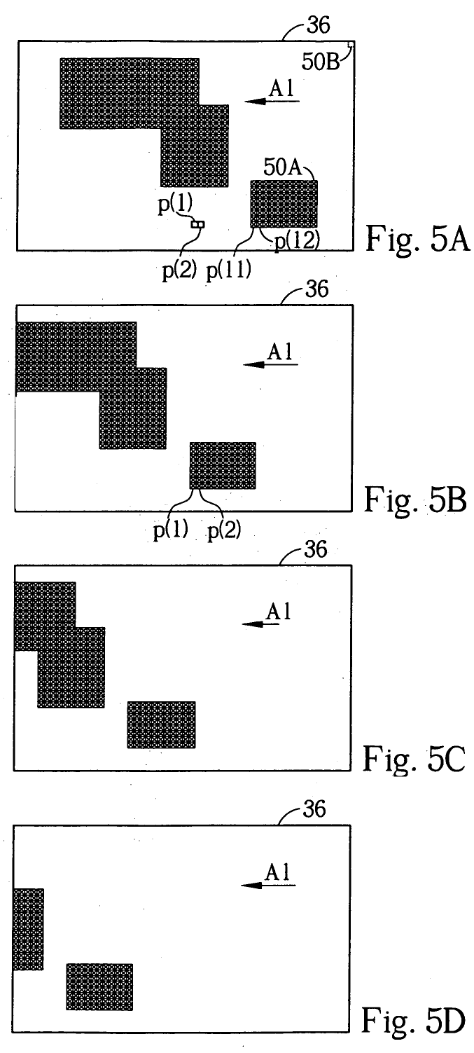

Please refer to FIGS. 5A-5D, which are schematic diagrams of varying pictures in a first embodiment of animation according to the present invention. Generally speaking, display devices of mobile phones are composed of pixels capable of forming a picture. The pictures in FIGS. 5A-5D are formed by pixels 50A and 50B displaying different colors (or different levels of brightness). The pixel 50A displays one color (e.g. black) and the pixel 50B displays another color (e.g. the background color of the display 36). Note that all pixels are not shown to clarify these figures, the pixels 50A and 50B being exemplary. FIGS. 5A-5D show a basic picture shift animation. FIG. 5A shows the original picture I(0) corresponding to the original image data D(0) (FIG. 4). To make the picture in FIG. 5A shift left (the direction of the arrow A1), the controller 34 controls each pixel to display the color (or brightness) of a pixel to the right so as to orderly calculate all of the image data corresponding to the varying pictures. For example, the colors (or levels of brightness) of pixels in a varying picture in FIG. 5A are changed to those of the tenth pixel to the right of each pixel (that is pixels p(1), P(2) . . . respectively show the colors (or levels of brightness) of pixels P(11), P(12) . . . ) for generating the varying picture in FIG. 5B. Therefore, the controller 34 can calculate image data of the varying pictures is FIGS. 5B to 5C according to the original varying picture in FIG. 5A, and generate a left shift animation by sequentially displaying these varying pictures on the display 36.

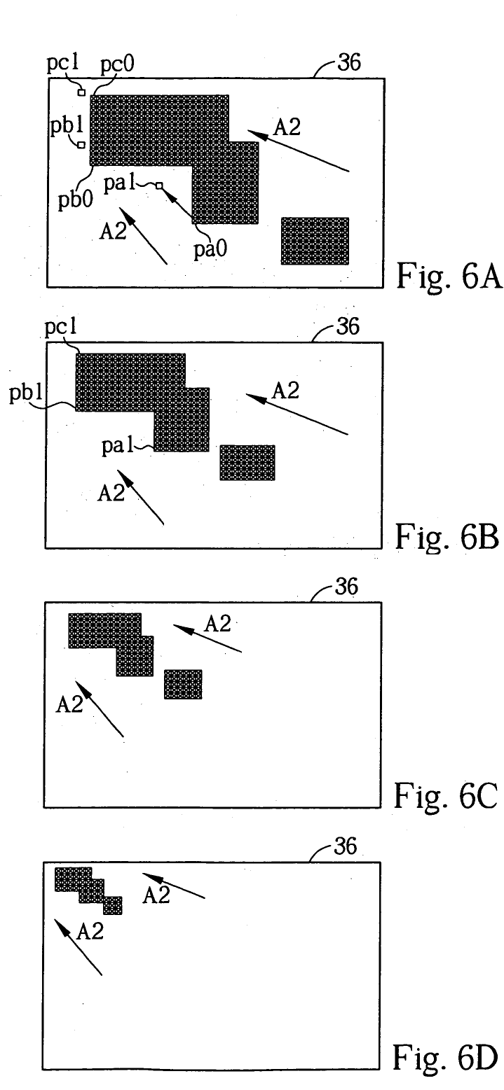

In addition to the shift animation described previously, the present invention also provides a different type of animation according to original image data. Please refer to FIGS. 6A-6D, which are schematic diagrams of varying pictures in a second embodiment of animation according to the present invention. FIGS. 6A-6D shows an original picture being animated to appear to zoom-out in an up and leftward direction (the direction of the arrow A2). To calculate this kind of animation, positions of pixels in the original picture are given coordinates, and the dimensions of the picture follow a coordinate system. In FIG. 6A, when zooming out along the direction of arrow A2, the coordinates of a pixel pa0 are changed to those of a pixel pal. Similarly, coordinates of pixels pb0 and pc0 respectively are changed to positions of pixels pb1 and pc1. Colors (or levels of brightness) of pixels pa0, pb0, pc0 . . . are respectively shown at pixels pa1, pb1, pc1 . . . In this way, image data in FIGS. 6B-6D are generated from the original picture in FIG. 6A to sequentially produce all varying pictures of the animation.

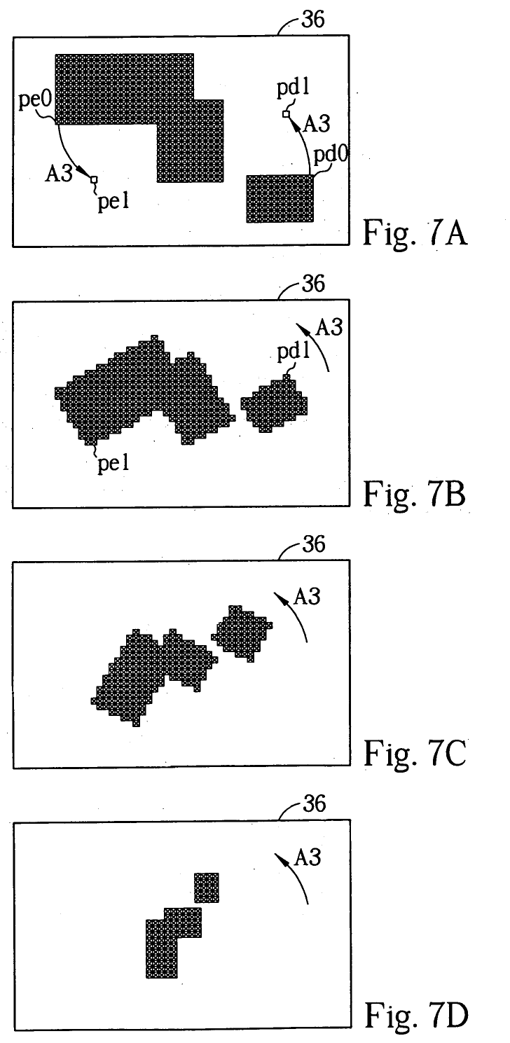

Following the similar method as that described above, a rotating and zooming animation of the picture can also be generated from the original image data. Please refer to FIGS. 7A-7D, which are schematic diagrams of varying pictures in a third embodiment of animation according to the present invention. A combination rotation-zoom is based on positions of all pixels in the coordinate system. Positions of pixels pd0 and pe0 are respectively rotationally moved to those of pixels pd1 and pe1. That is, pixels pd1 and pe1 respectively display colors (or levels of brightness) of pixels pd0 and pe0, with other pixels undergoing a similar operation to calculate the picture in FIG. 7B from the original picture in FIG. 7A. The pictures of FIGS. 7C and 7D are generated in much the same way, and are combined with the picture of FIGS. 7A and 7B to produce an animation of a picture rotating along the direction of the arrow A3 and zooming out at the same time.

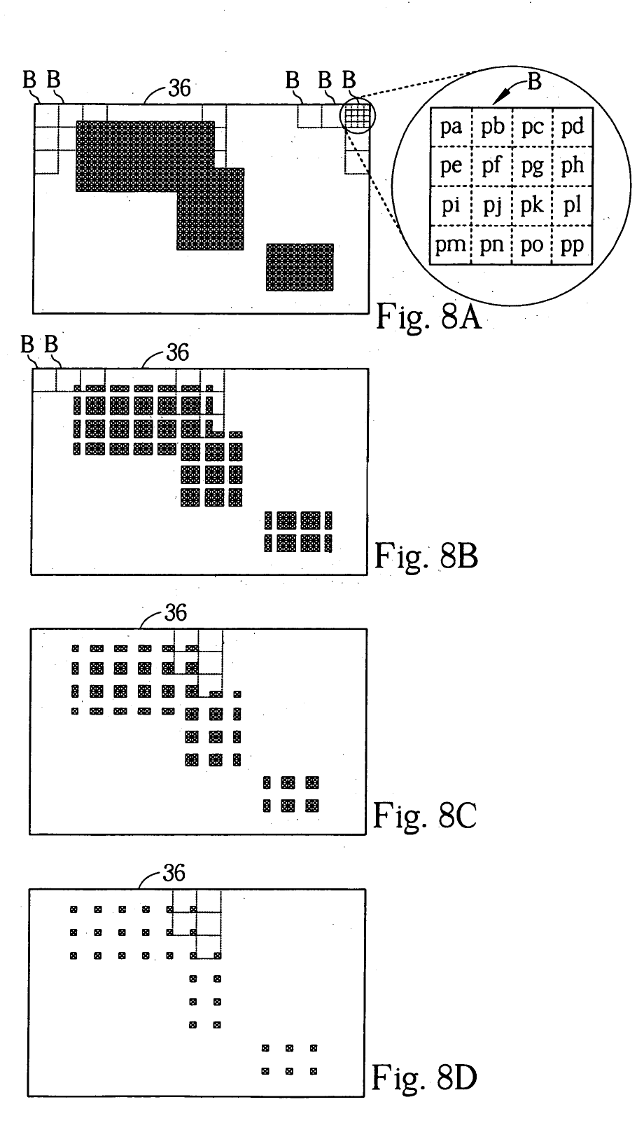

Please refer to FIGS. 8A-8D, which are schematic diagrams of varying pictures in a fourth embodiment of animation according to the present invention. The fourth embodiment is a fade-out animation. Pixels in the display 36 are divided into a plurality of fade-out units B having a plurality of pixels. In this embodiment, a fade-out unit B is a 4×4 array of pixels which are respectively marked as pixel pa, pb, pc, pd, pe, pf, pg, ph, pi, pj, pk, pl, pm, pn, po, and pp. Pixels in fade-out units increasingly display background color (or level of brightness) producing a fade-out animation. For example, pixels pa, pb, pc, pd, pe, pi, and pm in the unit B in FIG. 8A display background color (no matter what color these pixels originally displayed), while other pixels still display original color to generate a varying picture in FIG. 8B. Likewise, when pixels pa, pb, pc, pd, pe, pf, pg, ph, pi, pj, pm, and pn display background color, part of the original picture is replaced with the background color forming another varying picture shown in FIG. 8C. Finally, all pixels pa-pp in the unit B display the background color to form the last varying picture shown in FIG. 8D. By organizing the varying pictures of FIGS. 8A-8D a fade-out animation is generated. Reversing the original display order of FIGS. 8A-8D forms fade-in animation.

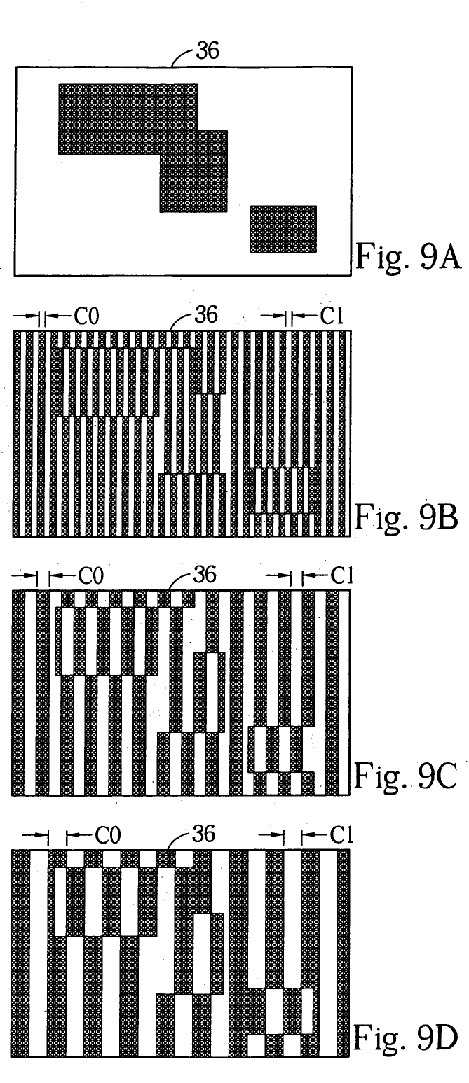

Please refer to FIGS. 9A-9D, which are schematic diagrams of varying pictures in a fifth embodiment of animation according to the present invention. In this embodiment, a picture is divided into several zones having a plurality of pixels. Pixels of some zones display the color (or level of brightness) of the original picture, and those of other zones display a contrasting color (or level of brightness) of the original picture. If FIG. 9A is the original picture, a plurality of zones C0 and C1 are set in FIGS. 9B-9D. Pixels of the zone C1 display the color (or level of brightness) of the original picture, and those of the zone C0 display a contrasting color (or brightness) of the original picture. Striped pictures in FIGS. 9B-9D are therefore generated. Changing the dimension of the zones C0 and C1 can produce different varying pictures to form another animation.

In addition to the embodiments of FIGS. 5A-9D, the present invention further comprises other kinds of animation, such as changing display order of the abovementioned animation (such as displaying in reverse), and combining different animations to form a new animation. For example, reversing the display order of FIGS. 6A-6D can generate a zoom-in animation; combining the rotation animation in FIGS. 7a-7D and the fade-out animation in FIGS. 8A-8D can generate a composite animation including both rotation and fade-out. In addition, the present invention is also capable of using different animations in different parts of the picture to form a new animation. For instance, the left side of the picture zooms out towards the upper left (as shown in FIGS. 5A-5D), and the right side zooms out towards the lower left. In the preferred embodiment of the present invention, the mobile phone 30 comprises a plurality of embedded animation calculation rules that allow the controller 34 to calculate the varying pictures for the animation. These rules can have different parameters to control calculated varying pictures and animation. The animation calculation rule controlling rotation animation in FIGS. 7A-7D can be based on different parameters to control directions of rotation, rotation angle, total angle of rotation, gradual zoom-out or zoom-in during the rotation period, percentage of zoom-out or zoom-in, time of displaying animation, an interval between varying pictures, a reverse control, and so on. In FIGS. 9A-9D, parameters can be used to control dimensions of the zones C0 and C1, and zoom-out or zoom-in of the zones for different varying pictures, etc. Users can use the control panel 42 on the mobile phone 30 to choose their favorite animation calculation rule and further set the parameters of these rules to freely control animation presented on the mobile phone 30.

The present invention provides users with choices of their favorite animation and pictures, and does not limit pictures from embedded animation. The present invention discloses calculating a plurality of varying pictures from one original picture for organizing animation. It is not difficult to input a single picture into a modern mobile phone, so users can input their favorite pictures into the mobile phone 30 as an original picture, and then use the controller 34 to generate a highly customized animation according to the original picture and the predetermined animation calculation rules.

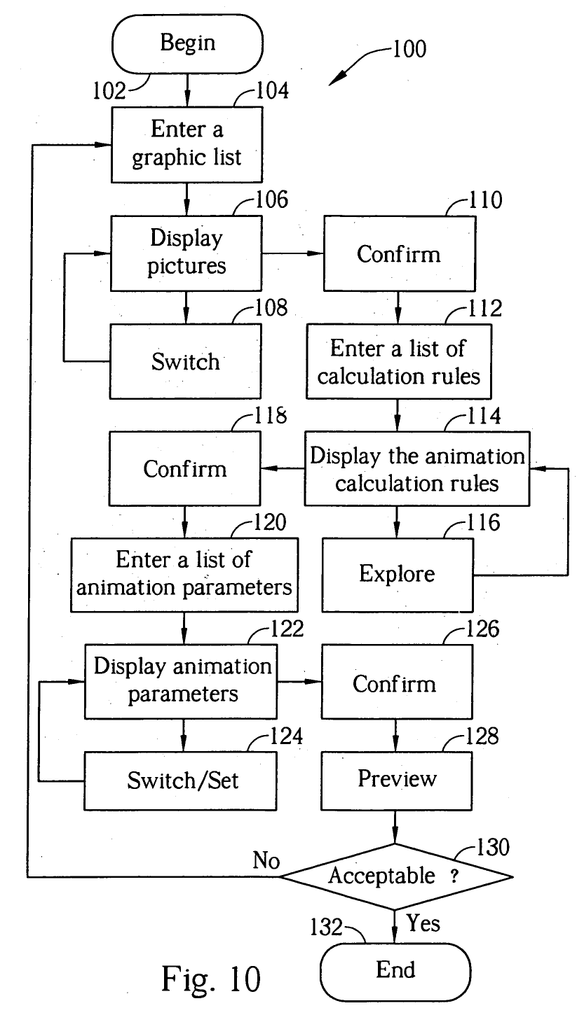

In the present invention, users can choose preferable original pictures and animation calculation rules to produce animation with personal style. The display 36 of the mobile phone 30 is used as a visual control interface to allow users to set up a personalized animation. Please refer to FIG. 10 and FIG. 3B. A process 100 in FIG. 10 allows users to set up animation according to the present invention. The process 100 includes the following steps:

Step 102: Begin. The display 36 of the mobile phone 30 displays a function list comprising the choice “animation settings” to allow a user to set up an animation. If the user selects this choice (the selection can be conducted by the control panel 42), the process 100 begins;

Step 104: Allow the user to select an original picture. The mobile phone 30 displays a graphic list and lets the user choose a picture to be the original picture;

Step 106: The display 36 displays the selectable pictures. Image data can be transmitted from computers to the mobile phone 30, or received by the radio module 32C via radio, or even taken by a mobile phone equipped with a camera. No matter how the image data are acquired, they are saved in the non-volatile memory 38 or the memory 40. In this step, the mobile phone 30 displays pictures generated from these image data;

Step 108: The user operates the control panel 42 to switch through different pictures on the display 36;

Step 110: The user operates the control panel 42 to decide which picture is the original picture;

Step 112: The display 36 assists the user in selecting animation calculation rules;

Step 114: Display the animation calculation rules. The display 36 is able to show easily understandable names of the rules such as “shift” (similar to animation in FIGS. 5A-5D), “zoom-out” (similar to animation in FIGS. 6A-6D), and “fade-out” (similar to animation in FIGS. 9A-9D);

Step 116: The user operates the control panel 42 to explore the animation calculation rules;

Step 118: The user operates the control panel 42 to select a favorite animation calculation rule;

Step 120: The display 36 allows the user to further set parameters corresponding to the chosen animation calculation rule. For example, parameters relating to the shifting animation of FIGS. 5A-5D include the direction of the shift (direction of the arrow A1), positional variation of the varying pictures, and so on. In FIGS. 6A-6D, parameters are used for controlling the zoom-out or zoom-in, changing a datum of the zoom-out or zoom-in, setting the direction of the arrow A2, etc;

Step 122: The display 36 displays parameters corresponding to the chosen animation calculation rule in step 120. These parameters can be predetermined, and then changed by the user in this step. A suggested range of the parameters can be displayed together with the parameter values. In addition, some parameters have a plurality of specific and predetermined values. For example, there are four parameters controlling the shift direction: up, down, right, and left;

Step 124: The user operates the control panel 42 to explore and set the parameters;

Step 126: The user operates the control panel 42 to ensure that all of the parameters in the animation calculation rule are set;

Step 128: Calculate varying pictures according to the original picture (in step 110), the animation calculation rule (in step 118), and the parameters corresponding to the rule (in step 126). The user can preview the organized animation on the display 36;

Step 130: If the user is satisfied with the animation, go to step 132; otherwise, go to step 104 to reset;

Step 132: The setting is saved in the memory 38 before the process ends, and the user is later able to watch the set animation when using the mobile phone 30;

In the prior art, animation of mobile phones is organized from many memory-intensive varying pictures stored in a memory. Additionally, users are limited to using animation embedded in a mobile phone and are not free to customize animation. In the present invention, varying pictures are calculated from an original picture under an animation calculation rule so that they need not be stored in memory. This improves the working efficiency of the memory. Furthermore, users are able to set the original picture, the animation calculation rule, and the related parameters as desired in order to present highly customized animations.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A mobile phone comprising:
a microphone for transforming voice into a sound signal;
a radio module for transmitting the sound signal via radio, receiving signals transmitted to the mobile phone via radio, and generating a corresponding communication signal;
a speaker for transforming the communication signal into sound wave;
a controller for controlling operations of the mobile phone;
a display for displaying pictures; and
a memory for storing an original picture;
wherein the controller is capable of generating a plurality of image data from the original picture to form a varying picture after a predetermined period of time.

2. The mobile phone of claim 1 wherein the varying picture is different from the original picture.

3. The mobile phone of claim 1 wherein the controller generates an original image data from the original picture.

4. The mobile phone of claim 3 wherein the varying picture is calculated from the original image data by a calculation rule.

5. The mobile phone of claim 4 wherein the calculation rule is selectable by a user of the mobile phone.

6. The mobile phone of claim 1 further comprising a control panel electrically connected with the controller for receiving control demands and transmitting the control demands to the controller.

7. The mobile phone of claim 6 wherein the controller sets the predetermined period of time according to the control demands sent from the control panel.

8. The mobile phone of claim 6 wherein the controller generates the first image data or the second image data according to the control demands transmitted from the control panel and makes different control demands correspond to the counterparts of the first image data or the second image data.

9. The mobile phone of claim 1 wherein the memory is a non-volatile memory.

10. A method of displaying animation on a mobile phone, the mobile phone comprising:
a microphone for transforming voice into a sound signal;
a radio module for transmitting the sound signal via radio, receiving signals transmitted to the mobile phone via radio, and generating a corresponding communication signal;
a speaker for transforming the communication signal into sound wave;
a display; and
a memory for storing an original image data, the original image data being displayed as an original picture on the display;
and the method comprising:
generating a first image data according to the original image data;
displaying a first picture on the display from the first image data;
generating a second image data according to the first image data; and
displaying a second picture on the display from the second image data after a predetermined period of time following the first picture being displayed;
wherein the first picture and the second picture are both different from the original picture.

11. The method of claim 10 wherein the first picture is different from the second picture.

12. The method of claim 10 wherein the first picture displays a part of the original picture.

13. The method of claim 10 wherein the second picture displays a part of the original picture.

14. The method of claim 10 further comprising a control panel electrically connected with the controller for receiving a control demand.

15. The method of claim 14 further comprising setting the predetermined period of time according to the control demand received by the control panel.

16. The method of claim 13 wherein the memory is a non-volatile memory.
